(19) United States
(12) Patent Application Publication
(10) Pub. No.: US 2022/0228066 A1
(43) Pub. Date: Jul. 21, 2022

(54) A Method for the Preparation of a Stable, Fire-Retardant Composition of Boron-Containing Compounds, the Composition so Obtained and a Method and a Use of Said Composition

(71) Applicant: International Suppliers and Contractors Inc., Baie-D'Urfé (CA)

(72) Inventor: Danilo Alfonso Guerra Padilla, Repentigny, Québec (CA)

(21) Appl. No.: 17/608,439

(22) PCT Filed: May 2, 2019
(86) PCT No.: PCT/CA2019/050580

§ 371 Date: Nov. 2, 2021

(51) Int. Cl. C09K 21/02

(52) U.S. Cl. CPC C09K 21/02; C09K 2103/00

(57) ABSTRACT

A fire-retardant composition having stable physical and chemical properties, comprising a salt of a first boron-containing compound in an amount A, a second boron-containing compound in an amount B, a first solvent comprising at least one organic solvent in an amount C, and a second solvent comprising water in an amount D. With respect to the total weight of the fire-retardant composition, A represents 15 to 45 wt.-%, B represents 15 to 46 wt.-%, C represents 0.2622×the amount B to 0.3944×the amount B wt.-%, and D represents 0.3549×the amount B to 0.4860×the amount B wt.-%. D=(the amount A+the amount B+the amount C); and 100−(the amount A+the amount B+the amount C) is greater that D. A method of preparation, a use and a method for imparting fire-retardant properties to a substrate.

### CROSS-REFERENCE TO RELATED APPLICATION

This application is a U.S. National Stage entry of International Patent Application No. PCT/CA2019/050580, filed on May 2, 2019, for A Method for the Preparation of a Stable, Fire-Retardant Composition of Boron-Containing Compounds, the Composition so Obtained and a Method and a Use of Said Composition, the entire contents of which are incorporated by reference herein.

### FIELD OF THE INVENTION

The present invention relates to a method for the preparation of a stable, fire-retardant composition containing a first solvent comprising at least one organic solvent, a second solvent comprising water, at least one salt of a first boron-containing compound, and at least one second boron-containing compound. Also, the invention relates to the composition so obtained, and a use or a method involving of said composition for providing fire-retardant properties a substrate.

### DESCRIPTION OF THE BACKGROUND

Various fire-retardant compositions are known to be useful for application on various substrates having heat insulating properties (e.g. fabrics, wood, recycled papers, etc.) in order to further provide them with and fire-retardant properties. Examples of such compositions may consist of aqueous solutions of boric acid, aqueous solutions of mixtures of boric acid/borax, etc.

Canadian patent no. 1,057,184 relates to a fire-retardant composition which is useful for the treatment of particles prior to a step of consolidation of said particles into a particleboard panel. More particularly, the fire-retardant composition is an aqueous solution of boron compounds and sulfuric acid. More particularly, the boron compounds are selected from the group consisting of borax decahydrate (Na₂B₄O₇.10H₂O), borax dehydrated (Na₂B₄O₇), borax pentahydrate (Na₂B₄O₇.5H₂O), polybor® (Na₂B₈O₁₃.4H₂O), salts of meta or ortho boric acids and boric acid, in conjunction with the borate and sulfuric acid, to give a proper Na₂O to B₂O₃ ratio for maximum solubility of the final mixture. The sulfuric acid is of 90%. to 98% concentration and in a weight ratio of 1.5 to 4.0 boron compound to 1 of sulfuric acid. This aqueous solution has a pH in the range of 4.5 to 6.0. According to an aspect of CA patent no. 1,057,184, wood particles are treated (sprayed) with said aqueous solution prior to their consolidation into a particleboard panel. However, the low pH range (4.5-6.0) of this aqueous solution show the drawback of being corrosive. This may affect metals (pipings, electric wires, etc.). Also, Canadian patent no. 1,057,184 fails to provide information about the stability and viscosity of the aqueous solution. It is to be noted that such features are of the utmost importance from an industrial point of view (e.g. transport, application on the substrate, etc.).

U.S. Pat. No. 4,332,609 relates to a process of fertilizing plants with polyborates comprising the reaction product of a boric acid compound and an alkanolamine or an aliphatic polyamine. More particularly, U.S. Pat. No. 4,332,609 mentions that monoethanolamine contributes to increase the solubility of boric acid in an aqueous solution. However, U.S. Pat. No. 4,332,609 does not concern fire-retardant composition. Also, U.S. Pat. No. 4,332,609 fails to provide information about the stability and viscosity of the aqueous solution. As mentioned above, such features are of the utmost importance from an industrial point of view.

U.S. Pat. No. 4,844,725 relates to an aqueous solution of alkylammonium borate containing 7% to 13% boron, comprising 40% to 85% of the reaction product of boric acid and C₁-C₆-alkylamine, in a mole ratio of from 1.5:1 to about 3:1, 2% to 15% of an alcohol selected from the lower alkanols and lower alkylene glycols, and the balance water. The lower alkanols and alkylene glycols containing 1 to 6 carbon atoms. This aqueous boron containing compositions are especially useful as foliar sprays and as components of liquid fertilizer compositions. However, U.S. Pat. No. 4,844,725 does not concern fire-retardant composition. Also, this U.S. Pat. No. 4,844,725 fails to provide information about the stability and viscosity of the aqueous solution. As mentioned above, such features are of the utmost importance from an industrial point of view.

The article of Margaret Hemel, ed. 1st International conference on wood protection with diffusible preservatives: Proceeding 47355; 1990 Nov. 28-30; Nashville, Madison, Wis.: Forest Product Research Society: 1990: 39-41, relates to a combination of fire-retardant products (boric acid/borax) and explains its properties. This article mentions that fire-retardants modify the properties of wood combustion by reducing the surface flame spread, cause acid reactions of dehydration and cellulose catalysis, facilitate carbonization and reduce the heat of combustion.

U.S. Pat. No. 5,614,653 relates to methods for solubilizing boric acid to produce liquid, boron-containing solutions. More particularly, boric acid is added to a previously formed solution of a metal ion and ligand. The ligand must be capable of both complexing the metal ion and simultaneously coordinating or hydrogen bonding with the boric acid. Water is used as solvent. Solutions so obtained have high boron concentrations, preferred metal ions are the transition metals, and preferred ligands are alkanolamines, polyamines, dialkylaminoalkylamines and alkyldiaminecarboxylic acids and salts thereof. This method allows to obtain stable, clear solutions, preferably aqueous solutions, containing about 9-11 percent-by-weight or more boron. However, U.S. Pat. No. 5,614,653 is directed toward the preparation of a fertilizer, not a fire-retardant agent. Also, this U.S. Pat. No. 5,614,653 fails to provide information about the viscosity of the aqueous solution, and no information related to the effect of this composition of recycled paper. As mentioned above, such features are of the utmost importance from an industrial point of view.

U.S. Pat. No. 6,025,027 relates to a method for producing fire-retarding compounds for use with cellulose insulation materials. The fire-retarding compounds are prepared by mixing of boric acid/borax, except powdered borates are replaced by liquid borates to reduce the costs of chemicals involved. Also, solutions having high concentration (25-45%) can be prepared to make impregnation of the solutions into newspring paper more effective. However, this method shows the drawback of requiring the reaction of an alkaline hydroxide with the borax, and the application of an acid to generate boric acid that will provide the paper with fire-retardant properties. Also, another drawback is that an efficient control of the pH is required, and the size of particles and the viscosity may alter the efficiency of the fire-retarding compound.

Canadian patent no. 2,175,278 relates to a wood preservative obtained by mixing a powder-from copper oxide and a powder-form boron compound (disodium octaborate tetrahydrate) and optionally boric acid. The mixture is heated at 700 C to form a homogeneous solution that is applied and impregnated in a piece of wood that is then heated between 300-400° C. However, this wood preservative shows the drawback or requiring a large amount of energy for its preparation.

U.S. Pat. No. 6,517,748 relates to a method of impregnating an object with a fire-retardant solution consisting essentially of an aqueous solution, free of phosphates, ammonia, and salts thereof, of nitrogen and boron containing compounds so the nitrogen and boron are dissolved therein and have a ratio nitrogen to boron ranging from 1.25:1 to 1.75:1 by weight. The fire-retardant solution can be used on various objects: wood, plywood and other wooden material. Also, the application of the fire-retardant solution can be made by soaking, brushing, spraying, etc. Also, vacuum and/or pressure techniques may be used. Also, the fire-retardant solution will not degrade objects when subjected to heat and/or humidity. Examples of nitrogen containing compounds are dicyandiamide, guanidine, cyanamide, urea, guanyl urea, melamine, biuret and mixtures thereof). Examples of boron-containing compounds are boric acid, metaboric acid, tetraboric acid, boric oxide, and alkaline borates such as sodium octaborate, sodium tetraborate, sodium pentaborate and their hydrates, as well as other metallic salts of boron and oxy acids of boron. This fire-retardant solution has low boron concentration, and persons skilled in the art are well aware that boron has a low solubility in water, and that higher concentration of boric acid/borates will become unstable (i.e formation of precipitates).

The article of Qingwen Wang et al, Entitled “Chemical mechanism of fire retardance of boric acid on wood”, VVood Science Technol. (2004) 38: 375-389, explains a fire-retardant mechanism of boric acid on wood. It is known that a physical mechanism exists to form a protective layer on the surface of wood. This article shows that boric acid is three time more efficient than guanyl urea phosphate (GUP). Also, concerning fire-retardant properties, a synergy was noted between boric acid and guanyl urea phosphate. However, this article fans to provide information about the possibility of increasing the solubility of boric acid in aqueous solutions.

US published patent application no. 2013/267479 relates to solutions including at least one boron complex obtained through the reaction between at least one boron salt, consisting of a borate anion selected from within the group consisting of metaborate anions, tetraborate anions, pentaborate anions, octaborate anions, decaborate anions, and the mixtures thereof, and a cation selected from within the group including sodium cations, potassium cations, ammonium cations, and the mixtures thereof, and at least one polyol and at least one amino compound. This US published patent application no. 2013/267479 also relates to a method for preparing said solutions and to the uses of said solutions. The mass concentration of elemental boron within the solution according to the invention is preferably between 5% and 15%. There is no information how to increase the solubility of boric acid, or a mixture of boric acid and a salt of boric acid, and obtain a stable solution containing said boric acid or a mixture of boric acid and a salt of boric acid. The solutions of this US published patent application are useful in the field of agriculture, not as fire-retardant, especially fire-retardant for recycled paper.

Prior art compositions of boron-containing compounds show the drawbacks of unable to simultaneously have a low viscosity, high concentrations in boron-containing compounds, stability over time and temperature variations, and minimal amounts of water.

It is to be noted that a relatively low viscosity is important for handling (via pumps and pipings) and/or application of the composition on a substrate to be treated, more particularly for impregnation of newsprint papers (preferably shredded newsprint paper) by spraying.

Also, it is to be noted that high concentrations in boron-containing compounds with minimal amounts of water are important to minimize transportation costs.

Also, it is to be noted that stability physical and chemical stabilities of the fire-retardant compositions over wide ranges of temperatures are important to avoid degradation of the properties of the fire-retardant compositions.

Therefore, there is a very strong need for a process allowing to obtain a fire-retardant composition of boron-containing compounds
having high concentrations in boron-containing compounds (e.g. boric acid(s) and borate(s));
having minimal amounts of water;
being stable over a large range of temperatures, preferably at temperatures varying from 10° C. to 80° C.; and
recovering its original viscosity, preferably 60 cps, when returning to an ambient temperature of 23° C.

The Applicant has surprisingly discovered that for obtaining a stable, non-viscous and efficient fire-retardant composition (even with high concentrations of boron-containing compounds, e.g. at least one of boric acid(s) and at least one of borate(s) salt(s)), it is necessary to prepare said fire-retardant composition according to a method involving very specific ratio between the constitutive ingredients of the composition.

Also, the Applicant has surprisingly discovered that when preparing a composition comprising at least one salt of a first boron-containing compound (i.e. at least one borate salt), a second boron-containing compound (at least one of boric acids), a first solvent comprising (preferably consisting of) at least one organic solvent, and a second solvent comprising (preferably consisting of) water, a reduction of the mass ratio between the first solvent and the second solvent allows to increase the amount of free water used in the solubilisation of the second bore-containing component.

Also, the Applicant has surprisingly discovered that the differences between the present invention and the prior art document is based on the presence of two solvents, one solvent being an organic solvent, and the other solvent being water, both completely miscible is all proportions, and two solid substances, an acid (e.g. boric acid) and a salt forming anions and cations (e.g. borate(s)). The stability of the fire-retardant composition obtained is bound directly to the concentration of the solvents.

### SUMMARY OF THE INVENTION

According to an embodiment, the invention provides a method for the manufacturing of compositions having fire-retardant properties to a substrate (e.g. recycled newsprint paper defining a cellusose wadding) useful as a material having heat insulating properties.

According to another embodiment, the substrate may be a monolithic bloc or assembly, or may be defining a fluff of shredded materials.

According to another embodiment, the substrate comprises (or preferably consist of cellulosic materials, and the composition may have a sufficient viscosity for an application on the substrate and/or an impregnation in the substrate.

According to another embodiment, the application of the composition on and/or in the substrate can be made by any appropriate means well known to persons skilled in the art, such as for example soaking, brushing, spraying, etc. Spraying is particularly preferred.

According to another embodiment, the application and/or impregnation of the fire-retardant composition on and/or in the substrate will render said substrate having fire-retardant properties (e.g. delay the spread of fire).

According to another embodiment, the obtained fire-retardant composition preferably has a low viscosity in order to be able to flow freely in piping (without adherence to the same), being applied by spraying and optionally depending the nature of the substrate, being impregnated within the substrate.

According to another embodiment, the obtained fire-retardant composition may define a concentrate, preferably having a high viscosity, to reduce storage and/or transportation costs. Said concentrate can be diluted to a working viscosity by mere addition of a diluent before use. Preferably, the viscosity of the concentrate may vary from 250 cps to more than 2000 cps, more preferably from 250 cps to 2000 cps. Preferably, the diluent is water. Indeed, the concentrate reveals to be soluble in water. Also, water does not affect the ratio boric acid/organic solvent and contributes to reduce the viscosity and eventual tackiness of the concentrate.

According to another embodiment, the obtained the fire-retardant composition does not have toxic effects. In this regard, the article of Beliër et al., “Free Boric Acid determination in Amine Borate reaction blends using solubility studies and ¹¹B-NMR-spectroscopy”, Lube Magazine, No. 65, Issue 97, August 2009, pp 19-22, and the article of Anderson, “Determination of residual free boric acid in amine borate condensate reaction products by ¹¹B NMR spectroscopy”, Lube Magazine, Vol. 83, Issue 110, August 2012, pp. 1-4, discuss that the solubility of fire-retardant agents, and the determination of free residual boric acid in reaction products of condensates of amino borates by RMN-B spectroscopy.

According to another embodiment, the invention relates to a method involving the use of mathematical formulas allowing to obtain obtaining a stable, non-viscous and efficient fire-retardant composition (even with high concentrations of boron-containing compounds), without having to carry out intermediary trial/error tests. Said mathematical formulas are based on certain properties of fire-retardant solutions, such as the solubility of boric acid, borate salts, first and second solvents, the ratio between water and the viscosity of the final fire-retardant composition.

According to another embodiment, the obtained mathematical formulas express the amount of each ingredients of the fire-retardant composition to be manufactured. The Applicant has surprisingly discovered that if the fire-retardant composition has a negative value between the amount in weight percent of the added water, and the required amount of water, then the fire-retardant composition will be unstable. However, if said difference is positive, then the fire-retardant composition is stable.

According to another embodiment, the present invention is for the preparation of prepare concentrated aqueous solutions of boron-containing compounds (e.g. lower, higher or equal to 10% wt.-% of boron atom). The amount of organic solvent is preferably lower than 20 wt.-% to avoid increasing the viscosity of the fire-retardant composition, and to have highly efficient fire-retardant composition. These compositions have fire-retardant properties and are highly stabilised.

According to another embodiment, the stable, non-viscous and efficient fire-retardant composition may have at least one of the following preferred properties:
A viscosity varying at 23° C. from 20 to 200 cps, more preferably 40 to 80 cps, much more preferably 50 to 70 cps, in order to allow said composition to flow easily within piping.
A stability for at least one year, more preferably at least 2 years, within temperature ranges that may be comprised between temperatures lower that −10° C. and higher than 80° C., more preferably within temperature ranges varying from 10° C. to 80° C. Said composition recovers their original properties and viscosity when returning to a surrounding working environment (e.g. about 23° C.). As an example, a frozen composition recovers its original properties when rewarmed at a temperature of about 23° C. (i.e. viscosity between 50 to 70 cps).

According to another embodiment, the stable, non-viscous and efficient fire-retardant composition may further have efficient fire-retardant properties on combustible substrates, preferably porous substrates such as for example cellulosic materials (e.g. recycled paper, cardboards, chips, etc.

According to another embodiment, the stable, non-viscous and efficient fire-retardant composition may further have efficient absorption properties on cellulosic materials such as recycled paper, cardboards, chips, etc.

According to another embodiment, if boric acid (which is known to be slightly soluble) is used, the salt of a boron-containing product is a borate salt, or a mixture of borates salts, provided with a greater amount of boron atoms than boric acid. The borate salt of the mixture of borate salts allows to increase the solubility of boric acid.

### DESCRIPTION OF PREFERRED EMBODIMENTS OF THE INVENTION

Before variants, examples or preferred embodiments of the invention be explained in detail, it is to be understood that the invention is not limited in its application to the details set forth in the following description. The invention is capable of other embodiments and of being practiced or of being carried out in various ways. Also, it is to be understood that the phraseology and terminology used herein is for the purpose of description and should not be regarded as limiting.

An embodiment of the invention relates to a method for preparing a fire-retardant composition useful for protecting a substrate, said fire-retardant composition having stable physical and chemical properties and comprising
a salt of a first boron-containing compound in an amount A, said salt of a first boron-containing compound being a borate salt or a mixture of borate salts;
a second boron-containing compound in an amount B, said second boron-containing compound being selected from the group consisting of boric acids;
a first solvent comprising at least one organic solvent, in an amount C, and
a second solvent comprising water, in an amount D;
   said method comprising the steps of
(i) mixing the amount C of the first solvent in the amount D of the second solvent to obtain a homogenous mixture of the first solvent and the second solvent;
(ii) mixing and dissolving the amount A of the salt of the first boron-containing compound in the homogeneous mixture obtained from step (i), to obtain a homogenous mixture of the first solvent, the second solvent and the salt of the first boron-containing compound;
(iii) mixing and dissolving the amount B of the second boron-containing compound in the homogeneous mixture obtained from step (iii), to obtain a homogeneous mixture of the first solvent, the second solvent, the salt of the first boron-containing compound and the second boron-containing compound;
   to provide the fire-retardant composition wherein
   the amount A of the salt of the first boron-containing compound represents from 15 to 45 wt.-% of the total weight of the fire-retardant composition,
   the amount B of the second boron-containing compound represents from 10 to 46 wt.-% of the total weight of the fire-retardant composition,
   the amount C of the first solvent represents from 0.2622×the amount B to 0.3944×the amount B wt.-% of the total weight of the fire-retardant composition; and
   the amount D of the second solvent represents from 0.3549×the amount
   B to 0.4860×the amount B wt.-% of the total weight of the fire-retardant composition; and
   wherein 100−(the amount A+the amount B+the amount C) is greater that D; and
      optionally said method further comprising a step of adding a diluent to the fire-retardant composition to adjust the viscosity a desired level, preferably said diluent being the first solvent, the second solvent or a mixture thereof. More preferably, the diluent is water.

According to another embodiment, the total amount of boron contained in the fire-retardant composition corresponds to the sum of the weight of the boron element(s) contained in the salt of the first boron-containing compound and the weight of the boron element(s) contained in the second boron-containing compound. As an example, the weight of the boron element of boric acid corresponds to 0.1748×the weight of boric acid, and the boron element of the salt of the disodium octaboron tetrahydrate corresponds to 0.20966×the weight of the disodium octaboron tetrahydrate.

According to another embodiment, the amount C of the first solvent may vary from 0.2622×the amount B of the second bore-containing compound to 0.3944×the amount B of the second bore-containing compound. Preferably, the optimal amount C of the first solvent is 0.3465×the amount B of the second bore-containing compound. As a non-limiting example, a fire-retardant composition containing 20 wt.-% of an organic solvent (e.g. monoethylamine) and 57.2 wt.-% of a second boron-containing compound (e.g. H₃BO₃ is 20/57.2 (i.e. 0.3465).

According to another embodiment, the amount D of the second solvent may vary from 0.3549×the amount of the second boron-containing compound B to 0.4860×the amount B of the second boron-containing compound. Preferably, the optimal amount D of the second solvent is 0.3860×the amount B of the second bore-containing compound. As a non-limiting example, a fire-retardant composition having a viscosity of 60 cps at 23° C., containing 22.28 wt.-% of the second solvent (e.g. water) and 57.72 wt.-% of a second boron-containing compound (e.g. H₃BO₃ is 22.28/57.72 (i.e. 0.3860).

Another embodiment of the invention relates to the method defined hereinabove, wherein the fire-retardant composition has a low viscosity.

Another embodiment of the invention relates to the method defined hereinabove, wherein the fire-retardant composition is a concentrate that is ready for a step adding a diluent to reduce the viscosity to a low viscosity before use, optionally with an agitation step.

Another embodiment of the invention relates to the method defined hereinabove, wherein the amount A varies from 35 to 45 wt.-% of the total weight of the fire-retardant composition.

Another embodiment of the invention relates to the method defined hereinabove, wherein the amount B varies from 35 to 45 wt.-% of the total weight of the fire-retardant composition.

Another embodiment of the invention relates to the method defined hereinabove, wherein steps (i) to (iii) are carried out between 20° C. and 80° C.

Another embodiment of the invention relates to the method defined hereinabove, wherein steps (i) to (iii) are carried out at about 80° C.

Another embodiment of the invention relates to the method defined hereinabove, wherein the viscosity of the fire-retardant composition varies from 20 cps to 200 cps at 23° C.

Another embodiment of the invention relates to the method defined hereinabove, wherein said fire-retardant composition has a viscosity at 23° C. that is between 50 and 70 cps.

Another embodiment of the invention relates to the method defined hereinabove, wherein the stability of the fire-retardant composition for at least one year, more preferably at least 2 years, within temperature ranges that may be comprised between temperatures lower that −10° C. and higher than 80° C., more preferably within temperature ranges varying from 10° C. to 80° C. Much more preferably, the formation of precipitate or multiphase separations is prevented, said composition may recover its original properties and viscosity (e.g. a varying from 20 to 200 cps, more preferably 40 to 80 cps, much more preferably 50 to 70 cps, in order to allow said composition to flow easily within piping), when returning to a surrounding wording environment (e.g. about 23° C.). As an example, a frozen composition recovers its original properties when rewarmed at a temperature of about 23° C.

Another embodiment of the invention relates to the method defined hereinabove, wherein the amount C in weight percent of the fire-retardant composition is of 0.2622×the amount B.

Another embodiment of the invention relates to the method defined hereinabove, wherein the amount C in weight percent of the fire-retardant composition is of 0.3060×the amount B.

Another embodiment of the invention relates to the method defined hereinabove, wherein the amount C in weight percent of the fire-retardant composition is of 0.3934×the amount B.

Another embodiment of the invention relates to the method defined hereinabove, wherein the amount C in weight percent of the fire-retardant composition is of 0.3465×the amount B.

Another embodiment of the invention relates to the method defined hereinabove, wherein the amount D in weight percent of the fire-retardant composition is of 0.3549×the amount B.

Another embodiment of the invention relates to the method defined hereinabove, wherein the amount D in weight percent of the fire-retardant composition is of 0.4860×the amount B.

Another embodiment of the invention relates to the method defined hereinabove, wherein the amount D in weight percent of the fire-retardant composition is of 0.4424×the amount B.

Another embodiment of the invention relates to the method defined hereinabove, wherein the amount D in weight percent of the fire-retardant composition is of 0.3860×the amount B.

Another embodiment of the invention relates to the method defined hereinabove, wherein the first solvent is at least one organic solvent containing in its molecule at least a nitrogen atom and/or at least one hydroxyl group.

Another embodiment of the invention relates to the method defined hereinabove, wherein the at least one organic solvent is selected from the group consisting of C₁-C₆ alkylamine, amino butanol, amino butanediol, 2-amino-1,3-propanediol, aminopropanol, ethanolamine, diethanolamine, triethanolamine, amino propanediol, dimethylaminopropylamine, ethylenediamine tetraacetic acid, and mixtures thereof.

Another embodiment of the invention relates to the method defined hereinabove, wherein the salt of the first boron-containing compound is selected from the group consisting of potassium borates, sodium borates, disodium octaborate tetrahydrate, dipotassium octaborate tetrahydrate, borax decahydrate, borax pentahydrate, salts of metaboric acid, salts of orthoboric acid, and mixtures thereof.

Another embodiment of the invention relates to the method defined hereinabove, wherein the second boron-containing compound is selected from the group consisting of orthoboric acid, metaboric acid, and mixtures thereof.

Another embodiment of the invention relates to the method defined hereinabove, wherein the second boron-containing compound is anhydrous boric acid.

Another embodiment of the invention relates to the method defined hereinabove, wherein the substrate is a cellulosic substrate.

Another embodiment of the invention relates to the method defined hereinabove, wherein the cellulosic substrate is selected from the group consisting of fabrics, recycled fabrics, papers, recycled papers, cardboards, recycled cardboards, cellulose fluffs, recycled cellulose fluffs, cellulose wadding, wood chips, wood particles, plywoods, etc.

Another embodiment of the invention relates to the method defined hereinabove, wherein the cellulosic substrate is recycled a newsprint paper.

Another embodiment of the invention relates to the method defined hereinabove, wherein the substrate is in the form of a shredded substrate defining a cellulosic wadding.

Another embodiment of the invention relates to a fire-retardant composition useful for protecting a substrate, said fire-retardant composition having stable physical and chemical properties and comprising
a salt of a first boron-containing compound in an amount A, said salt of a first boron-containing compound being a borate salt or a mixture of borate salts;
a second boron-containing compound in an amount B, said second boron-containing compound being selected from the group consisting of boric acids;
a first solvent comprising at least one organic solvent, in an amount C, and a second solvent comprising water, in an amount D;
   wherein
the amount A of the salt of the first boron-containing compound represents from 15 to 45 wt.-% of the total weight of the fire-retardant composition,
the amount B of the second boron-containing compound represents from 15 to 46 wt.-% of the total weight of the fire-retardant composition,
the amount C of the first solvent represents from 0.2622×the amount B to 0.3944×the amount B wt.-% of the total weight of the fire-retardant composition; and
the amount D of the second solvent represents from 0.3549×the amount B to 0.4860×the amount B wt.-% of the total weight of the fire-retardant composition; and
wherein 100−(the amount A+the amount B+the amount C) is greater that D.

Another embodiment of the invention relates to the fire-retardant composition defined hereinabove, wherein the fire-retardant composition is a concentrate.

Another embodiment of the invention relates to the fire-retardant composition defined hereinabove, wherein the fire-retardant composition has a low viscosity.

Another embodiment of the invention relates to the fire-retardant composition defined hereinabove, wherein the viscosity of the fire-retardant composition varies from 20 cps to 200 cps at 23° C.

Another embodiment of the invention relates to the fire-retardant composition defined hereinabove, wherein said fire-retardant composition has a viscosity at 23° C. that is between 50 and 70 cps.

Another embodiment of the invention relates to the fire-retardant composition defined hereinabove, wherein the amount A varies from 35 to 45 wt.-% of the total weight of the fire-retardant composition.

Another embodiment of the invention relates to the fire-retardant composition defined hereinabove, wherein the amount B varies from 35 to 45 wt.-% of the total weight of the fire-retardant composition.

Another embodiment of the invention relates to the fire-retardant composition defined hereinabove, wherein the stability of the fire-retardant composition has at least one of the following preferred properties:
a viscosity varying at 23° C. from 20 to 200 cps in order to flow easily within piping; and
a stability against precipitation or phase separation for at least one year within temperature ranges that may be comprised between temperatures lower that −10° C. and higher than 80° C., said composition recovering its original properties and viscosity when returning to a surrounding working environment of about 23° C.

Another embodiment of the invention relates to the fire-retardant composition defined hereinabove, wherein the amount C in weight percent of the fire-retardant composition is of 0.2622×the amount B.

Another embodiment of the invention relates to the fire-retardant composition defined hereinabove, wherein the amount C in weight percent of the fire-retardant composition is of 0.3060×the amount B.

Another embodiment of the invention relates to the fire-retardant composition defined hereinabove, wherein the amount C in weight percent of the fire-retardant composition is of 0.3934×the amount B.

Another embodiment of the invention relates to the fire-retardant composition defined hereinabove, wherein the amount C in weight percent of the fire-retardant composition is of 0.3465×the amount B.

Another embodiment of the invention relates to the fire-retardant composition defined hereinabove, wherein the amount D in weight percent of the fire-retardant composition is of 0.3549×the amount B.

Another embodiment of the invention relates to the fire-retardant composition defined hereinabove, wherein the amount D in weight percent of the fire-retardant composition is of 0.4860×the amount B.

Another embodiment of the invention relates to the fire-retardant composition defined hereinabove, wherein the amount D in weight percent of the fire-retardant composition is of 0.4424×the amount B.

Another embodiment of the invention relates to the fire-retardant composition defined hereinabove, wherein the amount D in weight percent of the fire-retardant composition is of 0.3860×the amount B.

Another embodiment of the invention relates to the fire-retardant composition defined hereinabove, wherein the first solvent is at least one organic solvent containing in its molecule at least a nitrogen atom and/or at least one hydroxyl group.

Another embodiment of the invention relates to the fire-retardant composition defined hereinabove, wherein the at least one organic solvent is selected from the group consisting of C₁-C₆ alkylamine, amino butanol, amino butanediol, 2-amino-1,3-propanediol, am inopropanol, ethanolamine, diethanolamine, triethanolamine, amino propanediol, dimethylaminopropylamine, ethylenediamine tetraacetic acid, and mixtures thereof.

Another embodiment of the invention relates to the fire-retardant composition defined hereinabove, wherein the salt of the first boron-containing compound is selected from the group consisting of potassium borates, sodium borates, disodium octaborate tetrahydrate, dipotassium octaborate tetrahydrate, borax decahydrate, borax pentahydrate, salts of metaboric acid, salts of orthoboric acid, and mixtures thereof.

Another embodiment of the invention relates to the fire-retardant composition defined hereinabove, wherein the second boron-containing compound is selected from the group consisting of orthoboric acid, metaboric acid, and mixtures thereof.

Another embodiment of the invention relates to the fire-retardant composition defined hereinabove, wherein the second boron-containing compound is anhydrous boric acid.

Another embodiment of the invention relates to the fire-retardant composition defined hereinabove, wherein the substrate is a cellulosic substrate.

Another embodiment of the invention relates to the fire-retardant composition defined hereinabove, wherein the cellulosic substrate is selected from the group consisting of fabrics, recycled fabrics, papers, recycled papers, cardboards, recycled cardboards, cellulose fluffs, recycled cellulose fluffs, cellulosic wadding, wood chips, wood particles and plywoods.

Another embodiment of the invention relates to the fire-retardant composition defined hereinabove, wherein the cellulosic substrate is recycled a newsprint paper.

Another embodiment of the invention relates to the fire-retardant composition defined hereinabove, wherein the substrate is in the form of a shredded substrate defining a cellulosic wadding.

Another embodiment of the invention relates to a concentrate fire-retardant composition for a substrate, said fire retardant composition having stable physical and chemical properties and a low viscosity, and comprising a salt of a first boron-containing compound, a second boron-containing compound, at least one first solvent and at least one second solvent, obtained by a method as defined hereinabove.

Another embodiment of the invention relates to a fire-retardant composition for a substrate, said fire retardant composition having stable physical and chemical properties and a low viscosity, and comprising a salt of a first boron-containing compound, a second boron-containing compound, at least one first solvent and at least one second solvent, obtained by a method as defined hereinabove.

Another embodiment of the invention relates to the fire-retardant composition defined above, having at least one of the following preferred properties:
A viscosity varying at 23° C. from 20 to 200 cps, more preferably 40 to 80 cps, much more preferably 50 to 70 cps, in order to allow said composition to flow easily within piping.
A stability for at least one year, more preferably at least 2 years, within temperature ranges that may be comprised between temperatures lower that −10° C. and higher than 80° C., more preferably within temperature ranges varying from 10° C. to 80° C. Said composition recovers their original properties and viscosity when returning to a surrounding working environment (e.g. about 23° C.). As an example, a frozen composition recovers its original properties when rewarmed at a temperature of about 23° C. (i.e. viscosity between 50 to 70 cps).

According to another embodiment, the stable, non-viscous and efficient fire-retardant composition may further have efficient fire-retardant properties on combustible substrates, preferably porous substrates such as for example cellulosic materials (e.g. recycled paper, cardboards, chips, etc.

According to another embodiment, the stable, non-viscous and efficient fire-retardant composition may further have efficient absorption properties on cellulosic materials such as recycled paper, cardboards, chips, etc.

Another embodiment of the invention relates to a use of the fire-retardant composition defined hereinabove, for imparting fire-retardant properties of a substrate.

Another embodiment of the invention relates to a method for imparting fire-retardant properties to a substrate, wherein the fire-retardant composition defined hereinabove is contacted with the substrate.

Another embodiment of the invention relates the method defined hereinabove, wherein the substrate is a cellulosic substrate.

Another embodiment of the invention relates the method defined hereinabove, wherein the fire-retardant composition is sprayed on the cellulosic substrate.

### EXAMPLES

### Protocol for the Manufacture of Fire-Retardant Solutions

Step (i): A reactor was filled with an amount of water and then heated at 80° C. Then an amount of an organic solvent (monoethanolamine) was added under stirring until obtaining a homogeneous mixture.

Step (ii): An amount of a boron salt (disodium octaborate tetrahydrate—known under the trade name Etidote 67; CAS 12280-03-4) was added under stirring to the mixture obtained from step (i). Stirring was continued until complete dissolution of the boron salt.

Step (iii): An amount of boric acid (H₃BO₃) is added to the homogeneous mixture obtained from step (ii), under stirring. Stirring was continued until obtaining a homogeneous solution.

The selected ratio of the amount of the organic solvent/amount of the boric acid is 0.3465; and the selected ratio of the amount of water/amount of the boric acid is 0.3860. Of course, the above-mentioned ratios are only illustrative of the optimal ratios, and they will work for all other claimed ratios.

### Protocol for the Application of a Fire-Retardant Solution to a Pad of Shredded Paper Obtained from a Recycled Newsprint Paper, and Measure of the Flame Retardant Properties of the Treated Pad

For each example defined hereinafter, the following sequence of steps was carried out (in triplicata):
Step 1, 6 g of cellulose wadding obtained from recycled newsprint paper were formed into a small pad having a rectangular shape 6 inches×5 inches×1 inch on an inclined plate. The cellulose wadding is obtained from recycled newsprint shredded in a «Oster» kitchen mixer. More particularly, 3 gr of newsprint paper was shredded for 3 minutes in the Oster mixer to obtain 3 grams of cellulose wadding, and then the operation was repeated with 3 gr of newsprint paper to obtain another 3 grams of cellulose wadding. Thus, a total of 6 grams of cellulose wadding was obtained and shaped as a rectangular pad. Therefore, for the tests, the pad has a density of about 6 gr per 30 cubic inches.
Step 2. 0.9 g of a fire-retardant solution as defined hereinafter, was sprayed with a conventional hand sprayer (e.g. a 750 ml hand sprayer), on the pad defined hereinabove. The flame-retardant solution was allowed to impregnate in the pad.
Step 3″ The pad impregnated with the fire-retardant solution was exposed to the flame of a torch for 6 seconds. The torch used was of the type currently used for cutting and/or welding metals (e.g. a Mag-Torch provided with a 14.1 oz propane gas cylinder.
Step 4, After the 6 seconds of step 3 mentioned above, the duration of the fire-retardant properties was measured with an electronic timer.

Also, for each example, the viscosity, and the stability of the chemical and physical properties of the fire-retardant composition were measure according to the following protocols.
The viscosity was measured at 23° C. with a Brookfield Synchro-Lectric Viscosimeter.
Physical properties were visually observed.

### Example 1

### Fire-Retardant Composition With boron at 11.8% by Weight

A fire-retardant solution was prepared according to the above-mentioned protocol. For preparing a fire-retardant solution comprising 31.5 wt.-% boric acid and 30 wt.-% Etidote 67. According to a first aspect of the invention, the amount of the first solvent (monoethanolamine) was determined to be 10.91 wt.-% (i.e. according to the equation 31.5 wt.-% of boric acid×0.3465).

Then, the theorical balance of water to reach 100 wt.-% of the solution was expected to be 27.59 wt.-% (i.e. 100 wt.-% −(31.5 wt.-%+30 wt.-%+10.91 wt.-%).

However, according to a second aspect of the invention, the amount of water was rather determined to be 12.16 wt.-% (i.e, according to the equation 31.5 wt.-% of boric acid×0.3860).

Therefore, the difference between the theorical balance of water and the real amount of water is positive (i.e. 27.59−12.16=+15.43). According to the invention, a positive result indicates when using less water, a stable product is obtained.

The product is a gel that stable (no precipitation, or separation of phase after 2 years. This gel is soluble in water and consequently, before use, can be diluted with water at a working viscosity (i.e. a viscosity which is suitable for an easy application, such as for example by spraying. Viscosity and flame-retardant properties are reported in the following tables 1 and 2.

### Example 2

### Fire-Retardant Composition with Boron at 8.05% by Weight

A fire-retardant solution was prepared according to the above-mentioned protocol. For preparing a fire-retardant solution comprising 31.5 wt.-% boric acid and 12 wt.-% Etidote 67. According to a first aspect of the invention, the amount of the first solvent (monoethanolamine) was determined to be 10.91 wt.-% (i.e. according to the equation 31.5 wt.-% of boric acid×0.3465).

Then, the theorical balance of water to reach 100 wt.-% of the solution was expected to be 45.6 wt.-% (i.e. 100 wt.-%−(31.5 wt.-%+12 wt.-%+10.91 wt.-%).

However, according to a second aspect of the invention, the amount of water was rather determined to be 12.16 wt.-% (i.e. according to the equation 31.5×0.3860).

Therefore, the difference between the theorical balance of water and the real amount of water is positive (i.e. 45.6−12.16=+33.44). According to the invention, a positive result indicates that when using less water, a stable fire-retardant solution is obtained

The fire-retardant solution is stable (no precipitation of separation of phase after 2 years. Viscosity and flame-retardant properties are reported in the following tables 1 and 2.

### Example 3

### Fire-Retardant Composition with Boron at 13.11% by Weight

A fire-retardant solution was prepared according to the above-mentioned protocol. For preparing a fire-retardant solution comprising 39 wt.-% boric acid and 30 wt.-% Etidote 67. According to a first aspect of the invention, the amount of the first solvent (monoethanolamine) was determined to be 13.51 wt.-% (i.e. according to the equation 39 wt.-% of boric acid×0.3465).

Then, the theorical balance of water to reach 100 wt.-% of the solution was expected to be 17.49 wt.-% (i.e. 100 wt.-%−(39 wt.-%+30 wt.-%+13.51 wt.-%).

However, according to a second aspect of the invention, the amount of water was rather determined to be 15.05 wt.-% (i.e. according to the equation 39 wt.-% of boric acid×0.3860).

Therefore, the difference between the theorical balance of water and the real amount of water is positive (i.e. 17.49−15.05=2.43). According to the invention, a positive result indicates that when using less water, a stable fire-retardant solution is obtained.

The fire-retardant solution is stable (no precipitation of separation of phase after 2 years. Viscosity and flame-retardant properties are reported in the following tables 1 and 2.

### Example 4

### Fire-Retardant Composition with Boron at 10.84% by Weight

A fire-retardant solution was prepared according to the above-mentioned protocol. For preparing a fire-retardant solution comprising 38 wt.-% boric acid and 20 wt.-% Etidote 67. According to a first aspect of the invention, the amount of the first solvent (monoethanolamine) was determined to be 13.17 wt.-% (i.e. according to the equation 38 wt.-% of boric acid×0.3465).

Then, the theorical balance of water to reach 100 wt.-% of the solution was expected to be 28.83 wt.-% (i.e. 100 wt.-%−(38 wt.-%+20 wt.-%+13.17 wt.-%).

However, according to a second aspect of the invention, the amount of water was rather determined to be 14.67 wt.-% (i.e. according to the equation 38 wt.-% boric acid×0.3860).

Therefore, the difference between the theorical balance of water and the real amount of water is positive (i.e. 28.83−14.67=14,16). According to the invention, a positive result indicates that when using less water, a stable fire-retardant solution is obtained.

The fire-retardant solution is stable (no precipitation of separation of phase after 2 years. Viscosity and flame-retardant properties are reported in the following tables 1 and 2.

### Example 5

### Fire-Retardant Composition with Boron at 10.14% by Weight

A fire-retardant solution was prepared according to the above-mentioned protocol. For preparing a fire-retardant solution comprising 40 wt.-% boric acid and 15.44 wt.-% Etidote 67. According to a first aspect of the invention, the amount of the first solvent (monoethanolamine) was determined to be 13.86 wt.-% (i.e. according to the equation 40 wt.-% of boric acid×0.3860).

Then, the theorical balance of water to reach 100 wt.-% of the solution was expected to be 31.14 wt.-% (i.e. 100 wt.-%−(40 wt.-%+15.44 wt.-%+13.86 wt.-%).

However, according to a second aspect of the invention, the amount of water was rather determined to be 15.44 wt.-% (i.e. according to the equation 15 wt.-%×0.3866).

Therefore, the difference between the theorical balance of water and the real amount of water is positive (i.e. 31.14−15.44=15.7). According to the invention, a positive result indicates that when using less water, a stable fire-retardant solution is obtained.

The fire-retardant solution is stable (no precipitation of separation of phase after 2 years. Viscosity and flame-retardant properties are reported in the following tables 1 and 2.

### Example 6

### Fire-Retardant Composition with Boron at 15.55% by Weight

A fire-retardant solution was prepared according to the above-mentioned protocol. For preparing a fire-retardant solution comprising 35 wt.-% boric acid and 45 wt.-% Etidote 67. According to a first aspect of the invention, the amount of the first solvent (monoethanolamine) was determined to be 12.13 wt.-% (i.e. according to the equation 35 wt.-% of boric acid×0.3465).

Then, the theorical balance of water to reach 100 wt.-% of the solution was expected to be 7.87 wt.-% (i.e. 100 wt.-%−(35 wt.-%+45 wt.-%+12.13 wt.-%).

However, according to a second aspect of the invention, the amount of water was rather determined to be 13.51 wt.-% (i.e. according to the equation 35 wt.-%×0.3860).

Therefore, the difference between the theorical balance of water and the real amount of water is positive (i.e. 7.87−13.51=−5.64). According to the invention, a negative result indicates when using more water that expected, an unstable fire-retardant solution is obtained.

Indeed, the fire-retardant solution is unstable (gel formation or precipitation after 2 years. Viscosity and flame-retardant properties are reported in the following tables 1 and 2.

### Example 7

### Fire-Retardant Composition with Boron at 10.66% by Weight

A fire-retardant solution was prepared according to the above-mentioned protocol. For preparing a fire-retardant solution comprising 37 wt.-% boric acid and 20 wt.-% Etidote 67. According to a first aspect of the invention, the amount of the first solvent (monoethanolamine) was determined to be 12.82 wt.-% (i.e. according to the equation 37 wt.-% of boric acid×0.3465).

Then, the theorical balance of water to reach 100 wt.-% of the solution was expected to be 30.18 wt.-% (i.e. 100 wt.-%−(37 wt.-%+20 wt.-%+12.82 wt.-%).

However, according to a second aspect of the invention, the amount of water was rather determined to be 14.28 wt.-% (i.e. according to the equation 37 wt.-% boric acid×0.3860).

Therefore, the difference between the theorical balance of water and the real amount of water is positive (i.e. 30.18−14.28=+15.90). According to the invention, a positive result indicates that when using less water, a stable fire-retardant solution is obtained.

The fire-retardant solution is stable (no precipitation or separation of phase after at least one year. Viscosity and flame-retardant properties are reported in the following tables 1 and 2.

### Example 8

### Fire-Retardant Composition with Boron at 11.71 by Weight

A fire-retardant solution was prepared according to the above-mentioned protocol. For preparing a fire-retardant solution comprising 37 wt.-% boric acid and 25 wt.-% Etidote 67. According to a first aspect of the invention, the amount of the first solvent (monoethanolamine) was determined to be 12.82 wt.-% (i.e. according to the equation 37 wt.-% of boric acid×0.3465).

Then, the theorical balance of water to reach 100 wt.-% of the solution was expected to be 25.18 wt.-% (i.e. 100 wt.-%−(37 wt.-%+25 wt.-%+12.82 wt.-%).

However, according to a second aspect of the invention, the amount of water was rather determined to be 14.28 wt.-% (i.e. according to the equation 37 wt.-% of boric acid×0.3860).

Therefore, the difference between the theorical balance of water and the real amount of water is positive (i.e. 25.18−14.28=+10.90). According to the invention, a positive result indicates that when using less water, a stable fire-retardant solution is obtained.

The fire-retardant solution is stable (no precipitation of separation of phase after 2 years. Viscosity and flame-retardant properties are reported in the following tables 1 and 2.

### Example 9

### Fire-Retardant Composition with Boron at 12.24% by Weight

A fire-retardant solution was prepared according to the above-mentioned protocol. For preparing a fire-retardant solution comprising 46 wt.-% boric acid and 20 wt.-% Etidote 67. According to a first aspect of the invention, the amount of the first solvent (monoethanolamine) was determined to be 15.94 wt.-% (i.e. according to the equation 46 wt.-% of boric acid×0.3465).

Then, the theorical balance of water to reach 100 wt.-% of the solution was expected to be 18.06 wt.-% (i.e. 100 wt.-%−(37 wt.-%+20 wt.-%+15.94 wt.-%).

However, according to a second aspect of the invention, the amount of water was rather determined to be 17.76 wt.-% (i.e. according to the equation 46 wt.-% of boric acid×0.3860).

Therefore, the difference between the theorical balance of water and the real amount of water is positive (i.e. 18.06−17.76=+0.31). According to the invention, a positive result indicates that when using less water, a stable fire-retardant solution is obtained.

The fire-retardant solution is stable (no precipitation of separation of phase after 2 years. Viscosity and flame-retardant properties are reported in the following tables 1 and 2.

### Example 10

### Fire-Retardant Composition with Boron at 9.44% by Weight

A fire-retardant solution was prepared according to the above-mentioned protocol. For preparing a fire-retardant solution comprising 36 wt.-% boric acid and 15 wt.-% Etidote 67. According to a first aspect of the invention, the amount of the first solvent (monoethanolamine) was determined to be 12.47 wt.-% (i.e. according to the equation 36 wt.-% of boric acid×0.3465).

Then, the theorical balance of water to reach 100 wt.-% of the solution was expected to be 36.53 wt.-% (i.e. 100 wt.-%−(36 wt.-%+15 wt.-%+12.47 wt.-%).

However, according to a second aspect of the invention, the amount of water was rather determined to be 13.90 wt.-% (i.e. according to the equation 36 wt.-% of boric acid×0.3860).

Therefore, the difference between the theorical balance of water and the real amount of water is positive (i.e. 36.53−13.90=+22.63). According to the invention, a positive result indicates when using less water a stable fire-retardant solution.

The fire-retardant solution is stable (no precipitation of separation of phase after 2 years. Viscosity and flame-retardant properties are reported in the following tables 1 and 2.

TABLE 1
Viscosity

| | AMOUNT OF | | |
|---|---|---|---|
| | ELEMENTAL | | |
| | BORON | VISCOSITY* | |
| EXEMPLES | (wt.-%) | (CPS at 23° C.) | CHARACTERISTICS |
| 1 | 11.8 | Not available | Gel** |
| 2 | 8.05 | 20 | Sprayable on CW*** |
| 3 | 13.11 | 1940 | Not sprayable on CW*** |
| 4 | 10.84 | 190 | Sprayable on CW*** |
| 5 | 10.14 | 90 | Sprayable on CW*** |
| 6 | 15.55 | >1940 | Not sprayable on CW*** |
| 7 | 10.66 | 190 | Sprayable on CW*** |
| 8 | 11.71 | 282.5 | Not sprayable on CW*** |
| 9 | 12.24 | 1020 | Not sprayable on CW*** |
| 10 | 9.44 | 42.5 | Sprayable on CW*** |

*Viscosimetre Brookfield, synchro-electric, FIELD 2/60, 23⁹ C.
***Cellulosic wadding

TABLE 2
FIRE-RETARDANT TEST

| | AMOUNT OF | | |
|---|---|---|---|
| | ELEMENTAL | | |
| | BORON | TIME | |
| EXAMPLES | (wt.-%) | (sec) | CHARACTERISTICS |
| 1 | 11.8 | 9.5 | Gel** |
| 2 | 8.05 | 10.5 | Applicable on CW*** |
| 3 | 13.11 | ND | Not applicable on CW*** |
| 4 | 10.84 | 8.5 | Applicable on CW*** |
| 5 | 10.14 | 8.0 | Applicable on CW*** |
| 6 | 15.55 | ND | Not applicable on CW*** |
| 7 | 10.66 | 8.0 | Applicable on CW*** |
| 8 | 11.71 | 7.0 | Not applicable on CW*** |
| 9 | 12.24 | ND | Not applicable on CW*** |
| 10 | 9.44 | 7.0 | Applicable on CW*** |

**Sprayed on CW*** after dilution with water at a viscosity of about 60 cps
***Cellulosic wadding

The above description of the embodiments should not be interpreted in a limiting manner since other variations, modifications and refinements are possible within the scope of the present invention. Accordingly, it should be understood that various features and aspects of the disclosed embodiments can be combined with or substituted for one another in order to form varying modes of the disclosed invention. The scope of the invention is defined in the appended claims and their equivalents.

1-58. (canceled)

59. A method for preparing a fire-retardant composition useful for protecting a substrate, said fire-retardant composition having stable physical and chemical properties and comprising
a salt of a first boron-containing compound in an amount A, said salt of a first boron-containing compound being a borate salt or a mixture of borate salts;
a second boron-containing compound in an amount B, said second boron-containing compound being selected from the group consisting of boric acids;
a first solvent comprising at least one organic solvent, in an amount C, and
a second solvent comprising water, in an amount D;
said method comprising the steps of
(i) mixing the amount C of the first solvent in the amount D of the second solvent to obtain a homogenous mixture of the first solvent and the second solvent;
(ii) mixing and dissolving the amount A of the salt of the first boron-containing compound in the homogeneous mixture obtained from step (i), to obtain a homogenous mixture of the first solvent, the second solvent and the salt of the first boron-containing compound;
(iii) mixing and dissolving the amount B of the second boron-containing compound in the homogeneous mixture obtained from step (iii), to obtain a homogeneous mixture of the first solvent, the second solvent, the salt of the first boron-containing compound and the second boron-containing compound;
to provide the fire-retardant composition wherein
the amount A of the salt of the first boron-containing compound represents from 15 to 45 wt.-% of the total weight of the fire-retardant composition,
the amount B of the second boron-containing compound represents from 15 to 46 wt.-% of the total weight of the fire-retardant composition,
the amount C of the first solvent represents from 0.2622×the amount B to 0.3944×the amount B wt.-% of the total weight of the fire-retardant composition; and
the amount D of the second solvent represents from 0.3549×the amount B to 0.4860×the amount B wt.-% of the total weight of the fire-retardant composition; and
wherein 100×(the amount A+the amount B+the amount C) is greater that D; and
optionally said method further comprising a step of adding a diluent to the fire-retardant composition to adjust the viscosity at a low level, said diluent being the first solvent, the second solvent or the mixture thereof.

60. The method according to claim 59, wherein the fire-retardant composition is a concentrate configured for dilution at a low viscosity before use.

61. The method according to claim 59, wherein the fire-retardant composition has a viscosity that ranges from 20 cps to 200 cps at 23° C.

62. The method according to claim 61, wherein the amount A varies from 35 to 45 wt.-% of the total weight of the fire-retardant composition, and wherein the amount B varies from 35 to 45 wt.-% of the total weight of the fire-retardant composition.

63. The method according to claim 61, wherein steps (i) to (iii) are carried out at a temperature varying from 20 to 80° C.

64. The method according to claim 61, wherein the stability of the fire-retardant composition has at least one of the following properties:
a viscosity varying at 23° C. from 20 to 200 cps in order to flow within piping; and
a stability against precipitation or phase separation for at least one year within temperature ranges that that include temperatures lower that −10° C. and higher than 80° C., said composition recovering its original properties and viscosity when returning to a surrounding working environment of about 23° C.

65. The method according to claim 62, wherein the amount C in weight percent of the fire-retardant composition is of 0.2622×the amount B, or the amount C in weight percent of the fire-retardant composition is of 0.3060×the amount B, or the amount C in weight percent of the fire-retardant composition is of 0.3934×the amount B, or the amount C in weight percent of the fire-retardant composition is of 0.3465×the amount B; and
wherein
the amount D in weight percent of the fire-retardant composition is of 0.3549×the amount B, or
the amount D in weight percent of the fire-retardant composition is of 0.4860×the amount B, or
the amount D in weight percent of the fire-retardant composition is of 0.4424×the amount B, or
the amount D in weight percent of the fire-retardant composition is of 0.3860×the amount B.

66. The method according to claim 62, wherein the first solvent is at least one organic solvent that includes at least a nitrogen atom or at least one hydroxyl group or at least a nitrogen atom and at least one hydroxyl group.

67. The method according to claim 62, wherein the salt of the first boron-containing compound is selected from the group consisting of potassium borates, sodium borates, disodium octaborate tetrahydrate, dipotassium octaborate tetrahydrate, borax decahydrate, borax pentahydrate, salts of metaboric acid, salts of orthoboric acid, and mixtures thereof.

68. The method according to claim 62, wherein the substrate is a cellulosic substrate.

69. A concentrate fire-retardant composition useful for preparing a fire-retardant composition which is useful for protecting a substrate, said fire retardant composition having stable physical and chemical properties and a low viscosity, and comprising a salt of a first boron-containing compound, a second boron-containing compound, at least one first solvent and at least one second solvent, obtained by a method as defined in claim 60.

70. A fire-retardant composition useful for protecting a substrate, said fire retardant composition having stable physical and chemical properties and a low viscosity, and comprising a salt of a first boron-containing compound, a second boron-containing compound, at least one first solvent and at least one second solvent, obtained by a method as defined in claim 61.

71. A fire-retardant composition useful for protecting a substrate, said fire-retardant composition having stable physical and chemical properties and comprising
a salt of a first boron-containing compound in an amount A, said salt of a first boron-containing compound being a borate salt or a mixture of borate salts;
a second boron-containing compound in an amount B, said second boron-containing compound being selected from the group consisting of boric acids;
a first solvent comprising at least one organic solvent, in an amount C, and
a second solvent comprising water, in an amount D;
wherein
the amount A of the salt of the first boron-containing compound represents from 15 to 45 wt.-% of the total weight of the fire-retardant composition,
the amount B of the second boron-containing compound represents from 15 to 46 wt.-% of the total weight of the fire-retardant composition,
the amount C of the first solvent represents from 0.2622×the amount B to 0.3944×the amount B wt.-% of the total weight of the fire-retardant composition; and
the amount D of the second solvent represents from 0.3549×the amount B to 0.4860×the amount B wt.-% of the total weight of the fire-retardant composition; and
wherein 100−(the amount A+the amount B+the amount C) is greater that D.

72. The fire-retardant composition according to claim 71, wherein the fire-retardant composition is a concentrate.

73. The fire-retardant composition according to claim 72, wherein the fire-retardant composition has a viscosity that ranges between 20 cps to 200 cps at 23° C.

74. The fire-retardant composition according to claim 73, wherein the amount A varies from 35 to 45 wt.-% of the total weight of the fire-retardant composition, and wherein the amount B varies from 35 to 45 wt.-% of the total weight of the fire-retardant composition.

75. The fire-retardant composition according to claim 74, wherein the stability of the fire-retardant composition has at least one of the following preferred properties:
a viscosity varying at 23° C. from 20 to 200 cps in order to flow within piping; and
a stability against precipitation or phase separation for at least one year within temperature ranges that may be comprised between temperatures lower that −10° C. and higher than 80° C., said composition recovering its original properties and viscosity when returning to a surrounding working environment of about 23° C.

76. The fire-retardant composition according to claim 74, wherein the amount C in weight percent of the fire-retardant composition is of 0.2622×the amount B, or
the amount C in weight percent of the fire-retardant composition is of 0.3060× the amount B, or
the amount C in weight percent of the fire-retardant composition is of 0.3934× the amount B, or
wherein the amount C in weight percent of the fire-retardant composition is of 0.3465× the amount B; and
wherein the amount D in weight percent of the fire-retardant composition is of 0.3549× the amount B, or
the amount D in weight percent of the fire-retardant composition is of 0.4860×the amount B, or
the amount D in weight percent of the fire-retardant composition is of 0.4424×the amount B, or
the amount D in weight percent of the fire-retardant composition is of 0.3860×the amount B.

77. The fire-retardant composition according to claim 73, wherein the first solvent is at least one organic solvent having at least one nitrogen atom or at least one hydroxyl group or at least one nitrogen atom and at least one hydroxyl group.

78. The fire-retardant composition according claim 74, wherein the salt of the first boron-containing compound is selected from the group consisting of potassium borates, sodium borates, disodium octaborate tetrahydrate, dipotassium octaborate tetrahydrate, borax decahydrate, borax pentahydrate, salts of metaboric acid, salts of orthoboric acid, and mixtures thereof.

79. The fire-retardant composition according to claim 74, wherein the substrate is a cellulosic substrate.

80. A method for imparting fire-retardant properties to a substrate, wherein a fire-retardant composition as defined in claim 70 is contacted with the substrate.
